(19) United States
(12) Patent Application Publication
(10) Pub. No.: US 2016/0070936 A1
(43) Pub. Date: Mar. 10, 2016

(54) ELECTRONIC APPARATUS

(71) Applicant: CANON KABUSHIKI KAISHA, Tokyo (JP)

(72) Inventor: Shuya Kaechi, Tokyo (JP)

(21) Appl. No.: 14/849,327

(22) Filed: Sep. 9, 2015

(30) Foreign Application Priority Data
Sep. 10, 2014 (JP) 2014-184588

(51) Int. Cl. G06F 21/81; G08B 5/36; G08B 21/18

(52) U.S. Cl. CPC G06F 21/81; G08B 21/185; G08B 5/36

(57) ABSTRACT

An electronic apparatus includes an authentication unit that executes an authentication process for authenticating a battery connected to the electronic apparatus, a holding unit that holds a value representing a result of the authentication process, wherein the value held by the holding unit is deleted in a case where the battery is removed from the electronic apparatus, or in a case where a voltage of the battery is equal to or less than a predetermined value, and a control unit that performs control to determine whether to cause the authentication unit to execute the authentication process according to the value held by the holding unit.

### BACKGROUND

1. Field of the Invention

The present invention relates to an electronic apparatus capable of authenticating a removable battery.

2. Description of the Related Art

In recent years, a battery to be connected to an electronic apparatus has been exclusively designed to be suitable for application of the electronic apparatus in many cases.

The battery exclusively designed for the electronic apparatus needs to satisfy a plurality of performance items and specific quality standards, including a size, charge-discharge behavior, temperature characteristics, safety, and a use time of the electronic apparatus. In general, performance and quality of the electronic apparatus are guaranteed when the apparatus is used together with such an exclusively designed battery.

The exclusively designed battery is designed and manufactured to satisfy the above-described performance items and specific quality standards. Meanwhile, batteries mimicking the appearance of the exclusively designed battery are manufactured and sold. Such counterfeit batteries include a battery which does not satisfy the above-described performance items and specific quality standards, and a battery which omits a protective device and circuit to lower the price.

The performance of the electronic apparatus may not be sufficient when the electronic apparatus is provided with the battery showing the deficient performance or the battery without the protective device and circuit. If there is a way of notifying a user that the counterfeit battery is being used, the user can recognize why the performance of the electronic apparatus cannot be achieved. As a result, the user can use the electronic apparatus more comfortably. Further, using the counterfeit battery may damage the electronic apparatus, and therefore, providing a notification unit can prevent occurrence of such a situation.

As a way of verifying the exclusively designed battery, in a known technique, the exclusively designed battery is provided with an authentication integrated circuit (IC) (see Japanese Patent Application Laid-Open No. 2009-272299). The electronic apparatus detects if a battery is legitimate by performing authentication through communication with the authentication IC. In the technique discussed in Japanese Patent Application Laid-Open No. 2009-272299, the battery incorporates a storage unit that stores information identifying the battery, and an authentication unit that communicates with an authentication unit of the electronic apparatus. The authentication unit of the electronic apparatus communicates with the authentication unit of the battery to verify whether the battery is appropriate. Power output from the battery can be used only when the authentication unit of the electronic apparatus successfully authenticates the battery.

In the technique discussed in Japanese Patent Application Laid-Open No. 2009-272299, a battery authentication process begins when the electronic apparatus is powered on or when the battery is replaced. Therefore, a user cannot start using the electronic apparatus until the battery authentication process is completed.

### SUMMARY

According to an aspect of the present invention, usability of an electronic apparatus that authenticates a removable battery is improved.

According to an aspect of the present invention, an authenticated battery can be immediately used.

According to an aspect of the present invention, there is provided an electronic apparatus including: an authentication unit that executes an authentication process for authenticating a battery connected to the electronic apparatus; a holding unit that holds a value representing a result of the authentication process, wherein the value held by the holding unit is deleted in a case where the battery is removed from the electronic apparatus, or in a case where a voltage of the battery is equal to or less than a predetermined value; and a control unit that performs control to determine whether to cause the authentication unit to execute the authentication process according to the value held by the holding unit.

According to an aspect of the present invention, there is provided a method including: causing an authentication unit to execute an authentication process for authenticating a battery connected to the electronic apparatus; causing a holding unit to hold a value representing a result of the authentication process, wherein the value held by the holding unit is deleted in a case where the battery is removed from the electronic apparatus, or in a case where a voltage of the battery is equal to or less than a predetermined value; and performing control to determine whether to cause the authentication unit to execute the authentication process according to the value held by the holding unit.

According to an aspect of the present invention, there is provided a non-transitory storage medium that stores a program for causing a computer to execute a method, the method including: causing an authentication unit to execute an authentication process for authenticating a battery connected to the electronic apparatus; causing a holding unit to hold a value representing a result of the authentication process, wherein the value held by the holding unit is deleted in a case where the battery is removed from the electronic apparatus, or in a case where a voltage of the battery is equal to or less than a predetermined value; and performing control to determine whether to cause the authentication unit to execute the authentication process according to the value held by the holding unit.

Further features and aspects of the present invention will become apparent from the following description of exemplary embodiments.

### BRIEF DESCRIPTION OF THE DRAWINGS

The drawings, which are incorporated in and constitute a part of the specification, illustrate exemplary embodiments, features, and aspects of the present invention.

FIG. 1 is a diagram illustrating an example of a schematic configuration of an electronic apparatus 101 in a first exemplary embodiment.

FIG. 2 is a diagram illustrating an example of a correspondence table of an authentication process state according to the first exemplary embodiment.

FIG. 3 is a flowchart illustrating an example of a control procedure of a battery authentication process according to the first exemplary embodiment.

FIG. 4 is a diagram illustrating an example of an image to be displayed on a display unit 109 when a battery authentication process fails.

FIG. 5 is a diagram illustrating an example of a correspondence table of an authentication process state according to a second exemplary embodiment.

FIG. 6 is a flowchart illustrating an example of a control procedure in a battery authentication process according to the second exemplary embodiment.

FIG. 7 is a diagram illustrating an example of a correspondence table of an authentication process state according to a third exemplary embodiment.

FIG. 8 is a flowchart illustrating an example of a control procedure in a battery authentication process according to the third exemplary embodiment.

FIG. 9 is a diagram illustrating an example of a schematic configuration of an electronic apparatus 201 according to a fourth exemplary embodiment.

FIG. 10 is a diagram illustrating an example of a schematic configuration of an electronic apparatus 301 according to a fifth exemplary embodiment.

FIG. 11 is a diagram illustrating an example of a schematic configuration of an electronic apparatus 401 according to a sixth exemplary embodiment.

FIG. 12 is a diagram illustrating an example of a correspondence table of an authentication process state according to the sixth exemplary embodiment.

FIG. 13 is a flowchart illustrating an example of a control procedure in a battery authentication process according to the sixth exemplary embodiment.

FIG. 14 is a diagram illustrating an example of a schematic configuration of an electronic apparatus 601 according to a seventh exemplary embodiment.

FIG. 15 is a diagram illustrating an example of a schematic configuration of an electronic apparatus 801 according to an eighth exemplary embodiment.

### DESCRIPTION OF THE EMBODIMENTS

Exemplary embodiments, features, and aspects of the present invention will be described below with reference to the drawings.

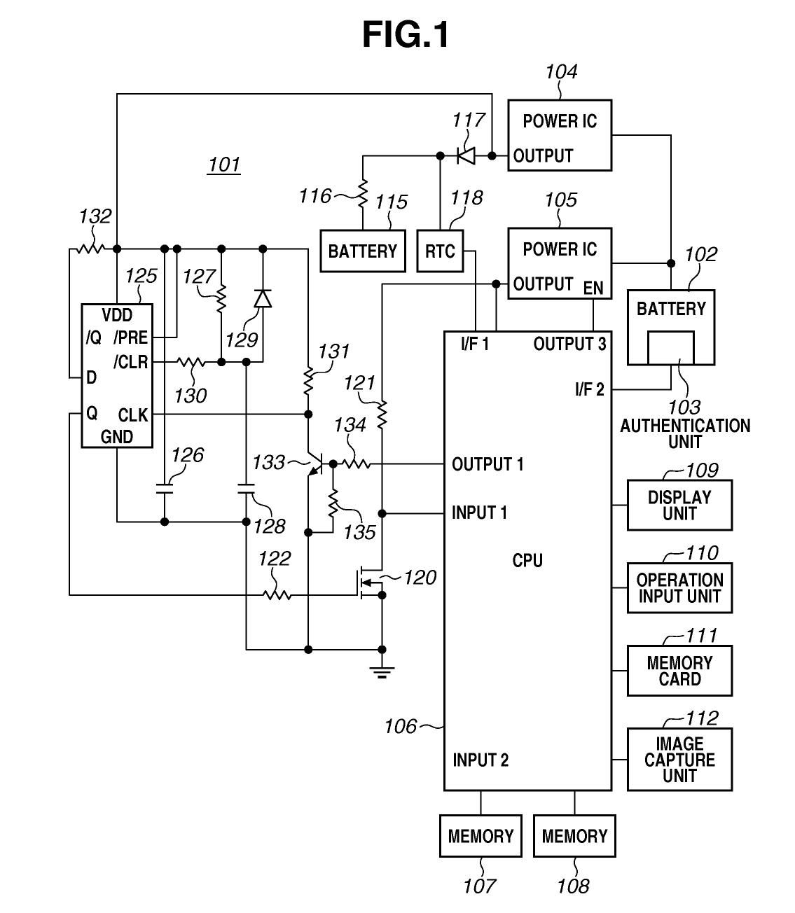

A first exemplary embodiment will be described below. FIG. 1 is a diagram illustrating an example of a schematic configuration of an electronic apparatus 101 according to the first exemplary embodiment.

A battery 102 is removable from the electronic apparatus 101. The battery 102 has an authentication unit 103. The authentication unit 103 can read and write internal authentication information by communicating with the outside battery 102, more specifically, with the electronic apparatus 101. The authentication unit 103 encrypts the internal authentication information by a method ensuring high security, and stores the encrypted information. Various known schemes can be used for the encryption method.

A CPU (central processing unit) 106 has a microprocessor for controlling operations of the electronic apparatus 101. In a state where the battery 102 is connected to the electronic apparatus 101, the authentication unit 103 connects to a communication port (I/F 2) of the CPU 106, and the CPU 106 authenticates the battery 102 in cooperation with the authentication unit 103. A first memory 107 is a memory used as a work area of the CPU 106. A second memory 108 is a memory that stores a program to be executed by the CPU 106. A part of the second memory 108 is composed of, for example, a rewritable nonvolatile memory such as a flash memory.

When an output voltage of the battery 102 is within a predetermined range, a power supply circuit 104 (hereinafter referred to as a “power IC (integrated circuit) 104”) operates regardless of whether the electronic apparatus 101 is powered on or off, and outputs a predetermined voltage. The output voltage of the power IC 104 is applied to a RTC (real-time clock) 118 via a diode 117, and further applied to a rechargeable battery 115 via a resistor 116. The RTC 118 provides current time and date information to a communication port (I/F 1) of the CPU 106, and is also used to measure a lapse of time. When the battery 102 is connected to the electronic apparatus 101 and the power IC 104 is in operation, the output of the power IC 104 serves as a power supply for the RTC 118 and charges the rechargeable battery 115. On the other hand, when the battery 102 is removed and the power IC 104 is not in operation, an output voltage of the rechargeable battery 115 is applied to the RTC 118 via the resistor 116, and the secondary battery 115 serves as a power supply (a backup power supply) for the RTC 118. This configuration allows the RTC 118 to operate continuously even in a state where the electronic apparatus 101 is powered off.

A power supply circuit 105 (hereinafter referred to as a “power IC 105”) is under control of the CPU 106, and outputs a predetermined voltage when the output voltage of the battery 102 is within a predetermined range. The CPU 106 operates by using the output voltage of the power IC 105 as a power supply. The output voltage of the power IC 105 also connects to a ground via a resistor 121 and an Nch MOS FET (N-channel Metal Oxide Semiconductor Field Effect Transistor) 120. A connection point between the resistance 121 and the Nch MOS FET 120 connects to an input port (INPUT 1) of the CPU 106, and the resistor 121 serves as a pull-up resistor that pulls up the input port (INPUT 1) of the CPU 106.

In the first exemplary embodiment, when the electronic apparatus 101 is powered off, the power IC 105 is not in operation. Accordingly, during power-off state, the CPU 106 is not in operation provided with no power supply. On the other hand, during power-on, the power IC 105 generates a predetermined voltage from the output voltage of the battery 102 and outputs the generated voltage from an output port. The CPU 106 operates by using the voltage of the output port of the power IC 105 as a power supply and takes in the voltage of the input port (INPUT 1) to control each part.

A display unit 109 displays an image such as image data and operation information on a screen of the display unit 109. The display unit 109 includes, for example, a liquid crystal display. An operation input unit 110 receives various operation performed by the user and sends operation information input from the user to the CPU 106. A memory card 111 is a storage medium that can read and write various data. An image capture unit 112 includes an optical unit having a lens and a driving system. The image capture unit 112 further includes an image capture element that converts an optical image generated by the optical unit into an image signal.

A D-FF (D flip flop) 125 is a state holding circuit capable of changing an output state according to an output of an output port (OUTPUT 1) of the CPU 106. The D-FF 125 is used as an information holding unit that holds (or stores) a value (or information) representing an authentication processed state of the battery 102. The output voltage of the power IC 104 is applied to a power terminal VDD and a preset terminal /PRE of the D-FF 125. When the output voltage of the battery 102 is within an operating range of the power IC 104, the power IC 104 outputs a constant voltage from an output port regardless of the operating state of the electronic apparatus 101. A Q output (which corresponds to a hold value 1) of the D-FF 125 is maintained by the output voltage of the power IC 104.

The power terminal VDD (the output voltage of the power IC 104 is applied thereto) of the D-FF 125 connects to a D terminal via a resistor 132. The resistor 132 is used for logic determination used in the D terminal of the D-FF 125. Further, the power terminal VDD of the D-FF 125 connects to aground GND via a capacitor 126, and connects to a /CLR terminal of the D-FF 125 via resistors 127 and 130, which are connected in serial. A diode 129 connects to the resistor 127 in parallel in a reverse direction, and a connection point between the resistors 127 and 130 connects to the ground GND via a capacitor 128. A logic state of the /CLR terminal of the D-FF 125 is determined using a CR time constant obtained based on the resistance of the resistor 127 and the capacitance of the capacitor 128.

The power terminal VDD of the D-FF 125 further connects to a collector of a npn transistor 133 via a resistor 131, and an emitter of the transistor 133 connects to the ground. The collector of the transistor 133 connects to a clock terminal CLK (a terminal CLK) of the D-FF 125. The output port (OUTPUT 1) of the CPU 106 connects to a base of the transistor 133 via a resistor 134. A resistor 135 is connected between the base and the emitter of the transistor 133. The CPU 106 switches the transistor 133 via the output port (OUTPUT 1) to input a clock-like trigger to the CLK terminal of the D-FF 125.

The Q output (the hold value 1) of the D-FF 125 connects to a gate of the Nch MOS FET 120 via a resistor 122. A switch including the Nch MOS FET 120 is turned on or off by the Q output (the hold value 1) of the D-FF 125.

A state transition of the D-FF 125 will be described. For example, in a state where the battery 102 is absent, the battery 102 that outputs a voltage within the operating range of the power IC 104 is connected to the electronic apparatus 101. Then, the Q output (the hold value 1) of the D-FF 125 is cleared (or deleted) with the CR time constant which is determined based on the resistance of the resistor 127 and the capacitance of the capacitor 128. In other words, the D-FF 125 starts operating from a clear state. This CR time constant is set such that a sufficient or more than sufficient time lapses from when the battery 102 is connected to the electronic apparatus 101 in the state where the battery 102 is absent, until when the output voltage of an output port of the power IC 104 becomes stable. In an initial state, the D-FF 125 is in the clear state, and therefore, the Q output (the hold value 1) of the D-FF 125 is low (L), and the Nch MOS FET 120 is in an OFF (no conductive) state.

In this state, the CPU 106 temporarily switches the transistor 133 ON by using the output port (OUTPUT 1), so that a signal transition, high (H)→low (L)→H high (H), is input to the CLK terminal of the D-FF 125. The signal making such a transition triggers a transition of the Q output (the hold value 1) of the D-FF 125 from low (L) to high (H). Since the Q output (the hold value 1) of the D-FF 125 thus transitions to H, the Nch MOS FET 120 enters an ON (conductive) state. This state of the D-FF 125 is maintained, if the battery 102 is connected to the electronic apparatus 101 and the output voltage of the battery 102 is within the operating range of the power IC 104.

When the battery 102 is removed from the electronic apparatus 101, the output voltage of the power IC 104 decreases and the D-FF 125 does not operate. As a result, the Q output (the hold value 1) of the D-FF 125 changes to L, and the Nch MOS FET 120 enters the OFF (non-conductive) state. When the battery 102 is connected to the electronic apparatus 101 again, since the D-FF 125 starts operating from the clear state as described above, the Q output (the hold value 1) of the D-FF 125 is cleared (or deleted) by this reattachment of the battery 102.

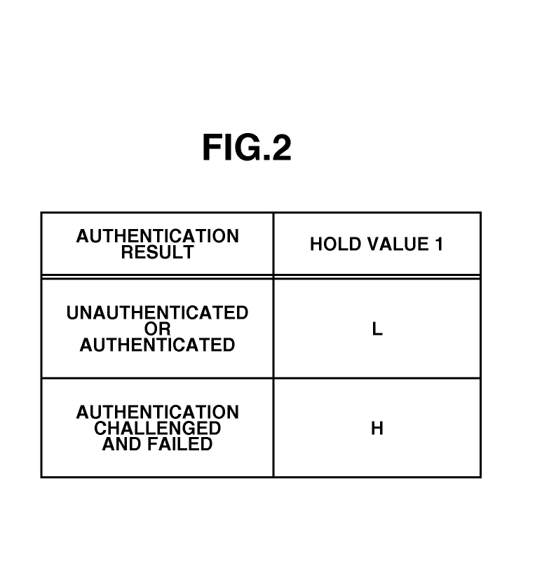

FIG. 2 illustrates a correspondence table illustrating a relationship between an authentication result of the battery 102 connected to the electronic apparatus 101 and the hold value 1 of the D-FF 125 (the state holding circuit). In the first exemplary embodiment, “unauthenticated” indicates a state where a battery authentication process to be performed between the CPU 106 and the authentication unit 103 of the battery 102 has not been executed. Further, “authenticated” refers to a state where authentication is successful as a result of performing the battery authentication process. Furthermore, “authentication challenged and failed” indicates a state where authentication fails in the battery authentication process.

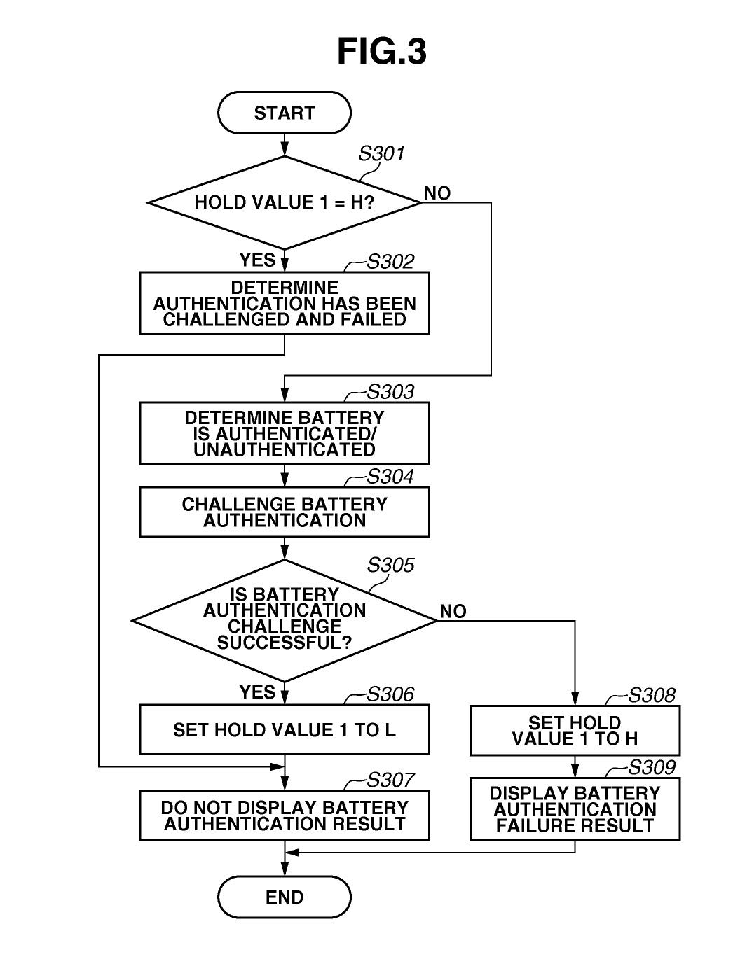

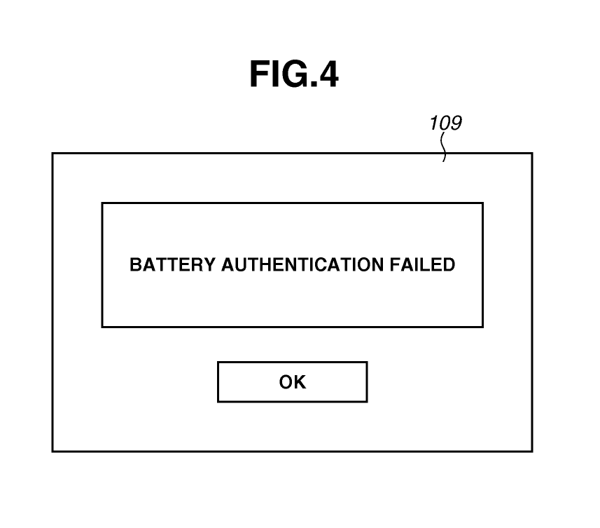

FIG. 3 is a flowchart illustrating an example of a control procedure of the battery authentication process according to the first exemplary embodiment. FIG. 4 is a diagram illustrating an image example to be displayed on the display unit 109 when the authentication process for the battery 102 fails.

In step S301, after the electronic apparatus 101 is powered on, the CPU 106 determines whether the Q output (the hold value 1) of the D-FF 125 is H. When the Q output (the hold value 1) of the D-FF 125 is H, the Nch MOS FET 120 is in the conductive state, and therefore, an electric potential of the input port (INPUT 1) of the CPU 106 is a ground (GND) electric potential. On the other hand, when the Q output (the hold value 1) of the D-FF 125 is L, the Nch MOS FET 120 is in the non-conductive state, and therefore, the electric potential of the input port (INPUT 1) of the CPU 106 is the electric potential of the output voltage of the power IC 105. This allows the CPU 106 to determine the Q output (the hold value 1) of the D-FF 125.

If the Q output (the hold value 1) of the D-FF 125 is H (Yes in S301), then in step S302, the CPU 106 determines that the authentication process for the battery 102 connected to the electronic apparatus 101 has been already executed and a result thereof is “authentication challenged and failed”. Next, in step S307, the CPU 106 does not display the battery authentication result and terminates the flow illustrated in FIG. 3.

If the Q output (the hold value 1) of the D-FF 125 is L (No in step S301), then in step S303, the CPU 106 determines that the authentication process for the battery 102 currently connected to the electronic apparatus 101 corresponds to “authenticated” or “unauthenticated”, and the operation proceeds to step S304.

In step S304, the CPU 106 performs the authentication process with the authentication unit 103 of the battery 102. In step S305, the CPU 106 determines whether the authentication process for the battery 102 in step S304 ends successfully. If the result is successful (Yes in step S305), then in step S306, the CPU 106 keeps the transistor 133 in off state and keeps the Q output (the hold value 1) of the D-FF 125 “L”. Then, in step S307, the CPU 106 does not display the battery authentication result, and terminates the flow illustrated in FIG. 3.

If the authentication process of the battery 102 in step S304 ends in failure (No in step S305), then in step S308, the CPU 106 switches the Q output (the hold value 1) of the D-FF 125 to “H”, by temporarily turning on the transistor 133 as described above. Next, in step S309, the CPU 106 displays the battery authentication result as failure on the display unit 109, and terminates the flow illustrated in FIG. 3.

The first exemplary embodiment describes the D-FF 125 as an example the state holding circuit that stores battery authentication failure, but other circuit or mechanical elements may be adopted. A circuit may be employed as long as it can set an output initial value, shift an output state by external control, and restore the state to the initial value when power supply stops. Such a circuit includes a JK-FF (JK flip-flop), a SR-FF (set/reset flip-flop), and a T-FF (toggle flip-flop).

In FIG. 2, the Q output (the hold value 1) of the D-FF 125 is “L” for “authenticated” or “unauthenticated”, and the Q output (the hold value 1) of the D-FF 125 is “H” for “authentication challenged and failed”. However, the correspondence between the authentication result and the Q output (the hold value 1) of the D-FF 125 is not limited to this example.

For example, the Q output (the hold value 1) of the D-FF 125 may be “H” for “authenticated” or “unauthenticated”, and the Q output (the hold value 1) of the D-FF 125 may be “L” for “authentication challenged and failed”. In this case, the logic is reversed between “H” and “L” at the conditional branching in step S301 and the state shift of the D-FF 125 in each of step S306 and step S308.

In the first exemplary embodiment, when the authentication of the battery 102 by the electronic apparatus 101 fails, information about the authentication failure can be stored in the D-FF 125. As long as the failed battery 102 in the authentication is connected to the electronic apparatus 101, the electronic apparatus 101 omits the battery authentication process at start-up and display of the authentication result. This allows a user to start using the electronic apparatus 101 quickly.

A second exemplary embodiment will be described below. When a result of authentication of the battery 102 is successful, information about the authentication success may be stored in a state holding circuit.

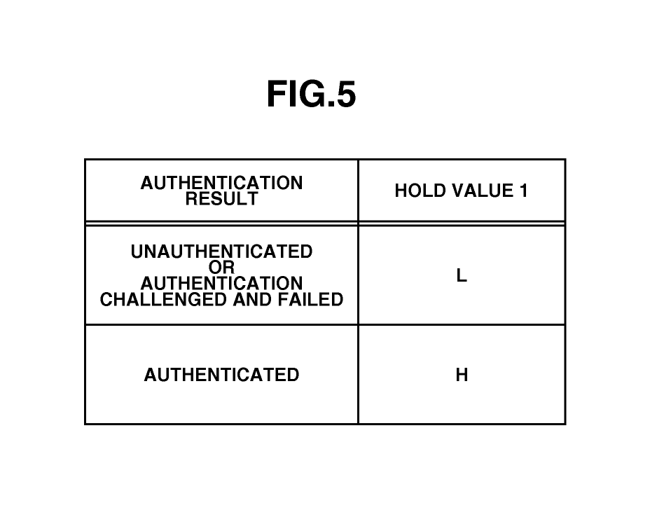

For example, when the result of authentication of the battery 102 by the electronic apparatus 101 is “unauthenticated” or “authentication challenged and failed”, the Q output (the hold value 1) of the D-FF 125 may be “L”, whereas when the result is “authenticated”, the Q output (the hold value 1) of the D-FF 125 may be “H”. FIG. 5 illustrates a correspondence table illustrating such a relationship.

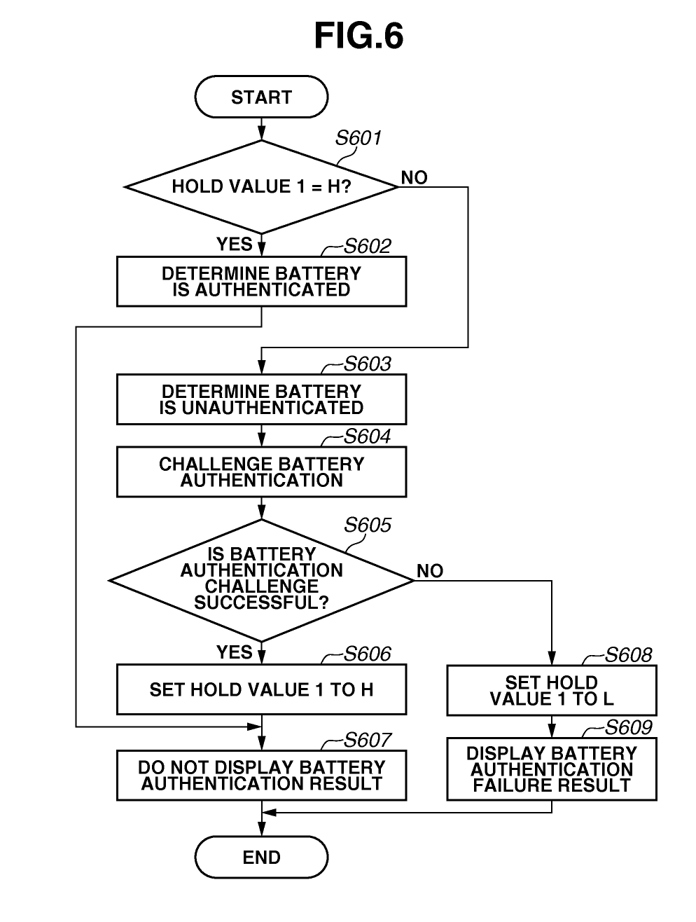

FIG. 6 is a flowchart illustrating an example of a control procedure of a battery authentication process in the second exemplary embodiment.

In step S601, after the electronic device 101 is powered on, the CPU 106 determines whether the Q output (the hold value 1) of the D-FF 125 is “H”. When the Q output (the hold value 1) of the D-FF 125 is “H” (Yes in step S601), then in step S602, the CPU 106 determines that the authentication process of the battery 102 connected to the electronic apparatus 101 has been already executed and the result thereof is “authenticated”. Then, in step S607, the CPU 106 omits to display the battery authentication result and terminates the flow illustrated in FIG. 6.

If the Q output (the hold value 1) of the D-FF 125 is “L” (No in step S601), then in step S603, the CPU 106 determines that the authentication process of the battery 102 currently connected to the electronic apparatus 101 corresponds to “unauthenticated” or “authentication challenged and failed”, and the operation proceeds to step S604.

In step S604, the CPU 106 performs the authentication process with the authentication unit 103 of the battery 102. In step S605, the CPU 106 determines whether the authentication process for the battery 102 in step S604 ends successfully. If the result is successful (Yes in step S605), then in step S606, the CPU 106 changes the Q output (the hold value 1) of the D-FF 125 to “H” by temporarily turning on the transistor 133 as described in the first exemplary embodiment. Then, in step S607, the CPU 106 omits to display the battery authentication result and terminates the flow illustrated in FIG. 6.

If the authentication process for the battery 102 in step S604 ends in failure (No in step S605), then in step S608, the CPU 106 keeps the transistor 133 in the off state and maintain the Q output (the hold value 1) of the D-FF 125 at “L”. Then, in step S609, the CPU 106 displays the battery authentication result as failure on the display unit 109 and terminates the flow illustrated in FIG. 6.

In FIG. 5, the Q output (the hold value 1) of the D-FF 125 is “L” for “unauthenticated” or “authentication challenged and failed”, and the Q output (the hold value 1) of the D-FF 125 is “H” for “authenticated”. However, the correspondence between the authentication result and the Q output (the hold value 1) of the D-FF 125 is not limited to this example.

For example, the Q output (the hold value 1) of the D-FF 125 may be “H” for “unauthenticated” or “authentication challenged and failed”, and the Q output (the hold value 1) of the D-FF 125 may be “L” for “authenticated”. In this case, the logic is reversed between H and L at the conditional branching in step S601 and the state shift of the D-FF 125 in each of step S606 and step S608.

In the second exemplary embodiment, when the authentication of the battery 102 by the electronic apparatus 101 is successful, information about the authentication success can be stored in the D-FF 125. As long as the failed battery 102 in the authentication is connected to the electronic apparatus 101, the electronic apparatus 101 omits to execute the battery authentication process at start-up and display the authentication result.

In the second exemplary embodiment, the authentication at start-up can be omitted with respect to the battery 102 that has been “authenticated”. This allows the user to start using the electronic apparatus 101 quickly.

In the case of the “authentication challenged and failed”, the user is not notified of the authentication failure in the first exemplary embodiment, but the user is notified of the authentication failure in the second exemplary embodiment. Whether which way is better is decided depending on preference of the user, and therefore, it is desirable to allow the user to select such options as deemed appropriate.

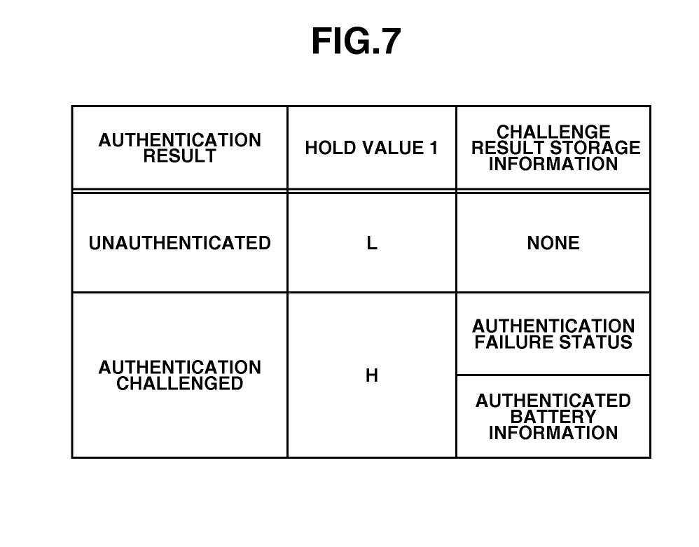

A third exemplary embodiment will be described below. The D-FF 125 may store information whether the battery 102 is unauthenticated or has been subjected to execution of authentication (“authentication challenged”). In addition, a nonvolatile memory (an authentication result memory) such as a flash memory may separately store failure/success of the authentication as an authentication result. For example, such an authentication memory may be prepared in the second memory 108. Such a modification will be described below as the third exemplary embodiment. In the following description, the Q output (the hold value 1) of the D-FF 125 is “L” in a case where the battery 102 is “unauthenticated”, whereas the Q output (the hold value 1) of the D-FF 125 is “H” in a case where the authentication process for the battery 102 has been already executed, i.e., in a case of “authentication challenged”. FIG. 7 illustrates a correspondence table describing such a relationship. Authentication challenge result storage information is also written down with it.

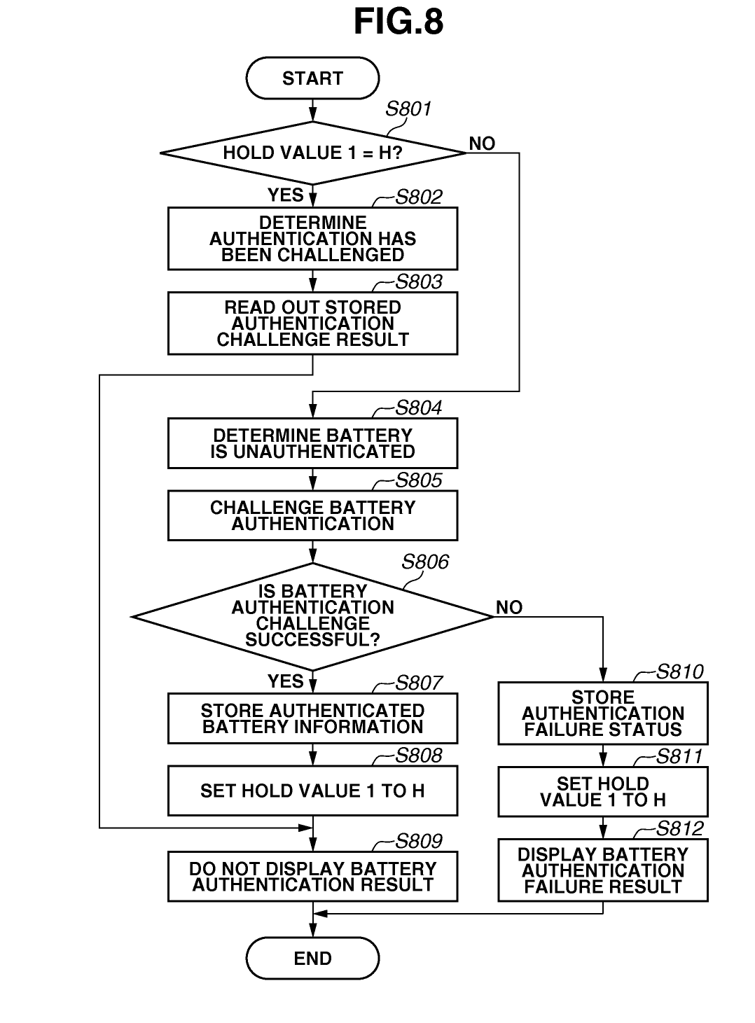

FIG. 8 is a flowchart illustrating an example of a control procedure of a battery authentication process in the third exemplary embodiment.

In step S801, when the power of the electronic apparatus 101 is turned on, the CPU 106 determines whether the Q output (the hold value 1) of the D-FF 125 is “H”. If the Q output (the hold value 1) of the D-FF 125 is “H” (Yes in step S801), then in step S802, the CPU 106 determines that the authentication process for the battery 102 currently connected to the electronic apparatus 101 has been already executed. In step S803, the CPU 106 reads out authentication result detailed information from the authentication result memory. The authentication result detailed information is either “authentication failure status” or “authenticated battery information”. The authenticated battery information includes, for example, information about the a date and time when battery authentication process ends successfully, a unique ID of the authentication unit 103 of the battery 102, and charge-discharge frequencies of the battery 102. The CPU 106 may change control of the electronic apparatus 101 based on the authentication result detailed information read out in step S803. After reading out the authentication result detailed information in step S803, the CPU 106 proceeds to step S809. In step S809, the CPU 106 omits to display the battery authentication result and terminates the flow illustrated in FIG. 8.

If the Q output (the hold value 1) of the D-FF 125 is “L” (No in step S801), then in step S804, the CPU 106 determines that the battery 102 currently connected to the electronic apparatus 101 is “unauthenticated”, and then the operation proceeds to step S805. In step S805, the CPU 106 performs the authentication process with the authentication unit 103 of the battery 102. In step S806, the CPU 106 determines whether the authentication process for the battery 102 in step S805 ends successfully. If the result is successful (Yes in step S806), then in step S807, the CPU 106 stores the authenticated battery information including the authentication process result into the authentication result memory. In step S808, the CPU 106 changes the Q output (the hold value 1) of the D-FF 125 to H, by temporarily turning on the transistor 133 as described in the first exemplary embodiment. Next, in step S809, the CPU 106 omits to display the battery authentication result and terminates the flow illustrated in FIG. 8.

If the authentication process for the battery 102 in step S805 ends in failure (No in step S806), then in step S810, the CPU 106 stores information about the authentication process result (authentication failure status) in the authentication result memory of the second memory 108. The authentication failure status includes, for example, information about the date and time when the battery authentication process fails, and a log of communication of the failed battery authentication process. In step S811, the CPU 106 changes the Q output (the hold value 1) of the D-FF 125 to “H” by temporarily turning on the transistor 133 as described in the first exemplary embodiment. Then, in step S812, the CPU 106 displays the battery authentication result as failure on the display unit 109 and terminates the flow illustrated in FIG. 8.

In FIG. 7, the Q output (the hold value 1) of the D-FF 125 is “L” for “unauthenticated”, and the Q output (the hold value 1) of the D-FF 125 is “H” for “authentication challenged”. However, the correspondence between the execution/non-execution of the authentication, and the Q output (the hold value 1) of the D-FF 125 is not limited to this example.

For example, the Q output (the hold value 1) of the D-FF 125 may be “H” for “unauthenticated”, and the Q output (the hold value 1) of the D-FF 125 may be “L” for “authentication challenged”. In this case, the logic is reversed between “H” and “L” at the conditional branching in step S801 and the state transition of the D-FF 125 in each of step S808 and step S811.

In the third exemplary embodiment, information about the execution/non-execution of the authentication of the battery 102 is stored in the D-FF 125, and information about the result of the battery authentication process is stored in the second memory 108. As long as the same battery 102 remains connected to the electronic apparatus 101, the electronic apparatus 101 omits to execute the battery authentication process at start-up and to display the authentication result. This allows the user to start using the electronic apparatus 101 quickly.

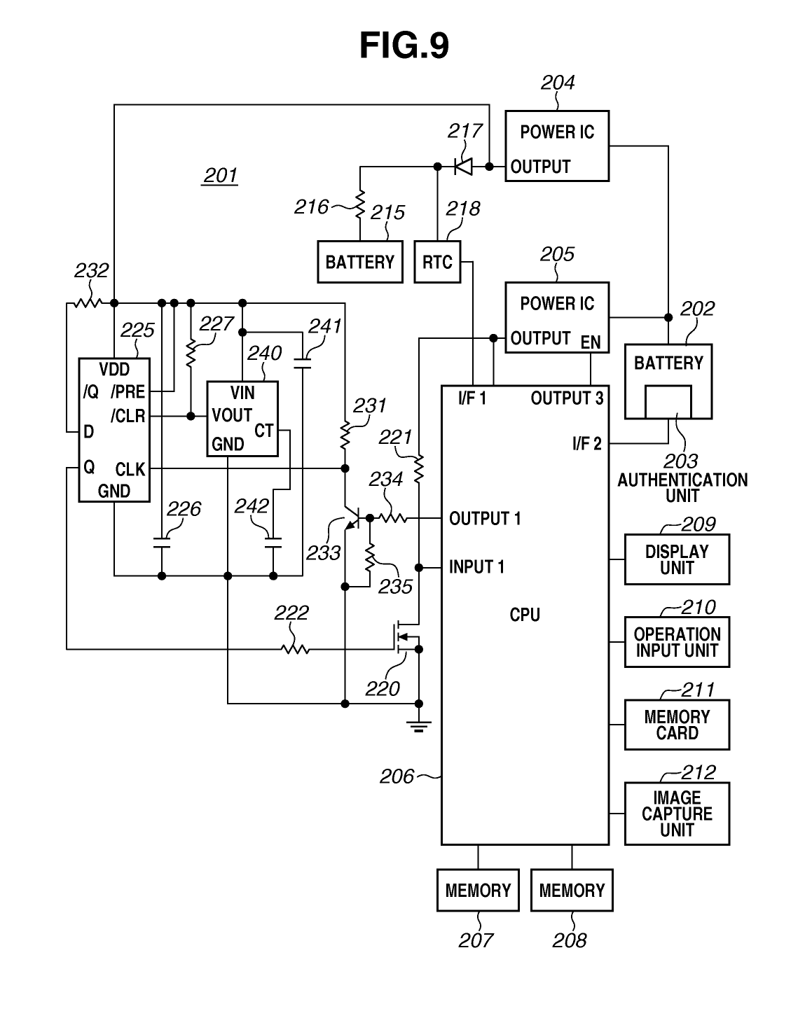

A fourth exemplary embodiment will be described below. FIG. 9 is a diagram illustrating an example of a schematic configuration of an electronic apparatus 201 according to the fourth exemplary embodiment. In the electronic apparatus 201 according to the fourth exemplary embodiment, a logic at the time of an initial operation of a D-FF 225 is determined by applying an output of a voltage detection circuit 240 to a /CLR terminal of the D-FF 225 corresponding to the D-FF 125. As with the first to third exemplary embodiments, the D-FF 225 starts operating from a clear state. Components indicated by reference numerals 202 to 235 illustrated in FIG. 9 correspond to components indicated by reference numerals 102 to 135 illustrated in FIG. 1, respectively, and basically operate in a similar way. The correspondence table illustrated in each of FIGS. 2, 5, and 7, as well as the flowchart illustrated in each of FIGS. 3, 6, and 8 are applicable to the fourth exemplary embodiment.

A part different from the first exemplary embodiment illustrated in FIG. 1 will be described. The voltage detection circuit 240 detects an output voltage of a power IC 204. The voltage detection circuit 240 sets an output VOUT to L if the detected voltage is less than a threshold voltage, and sets the output VOUT to “H” if the detected voltage is equal to or greater than the threshold voltage. The voltage detection circuit 240 uses the output voltage of the power IC 204 as a power supply, and therefore constantly operates regardless of whether the electronic apparatus 201 is powered on or off. The output VOUT of the voltage detection circuit 240 connects to the /CLR terminal of the D-FF 225.

A capacitor 242 is provided to set a delay time which corresponds to the time period from when the voltage equal to or greater than the threshold voltage is detected by the voltage detection circuit 240 until when the output VOUT transitions from L to H. The capacitor 242 is set to have a capacitance that can ensure the delay time that is sufficient or more than sufficient to stabilize a voltage of the power IC 204 from when the power IC 204 begins to output a reasonable voltage after a battery 202 is connected to the electronic apparatus 201.

By providing the voltage detection circuit 240, an initial logical value of the /CLR terminal of the D-FF 225 is obtained which is more stable than in the configuration illustrated in FIG. 1.

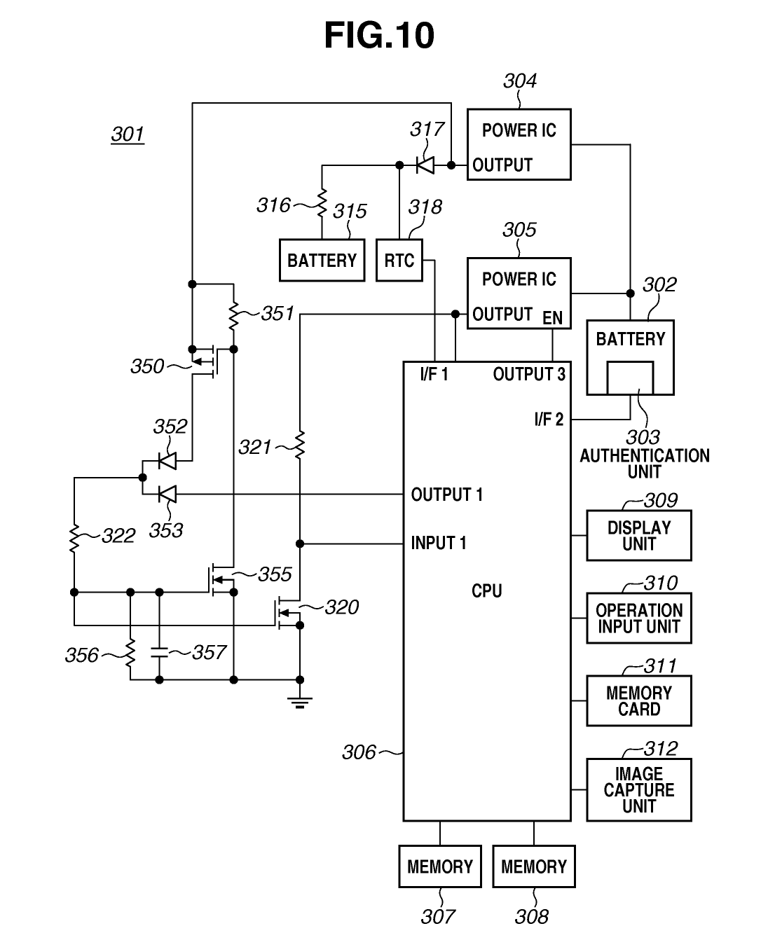

A fifth exemplary embodiment will be described below. FIG. 10 is a diagram illustrating an example of a schematic configuration of an electronic apparatus 301 in the fifth exemplary embodiment. In the electronic apparatus 301 of the fifth exemplary embodiment, a state holding circuit includes a Pch MOS FET (P-channel Metal Oxide Semiconductor Field Effect Transistor) and an Nch MOS FET. Components indicated by reference numerals 302 to 321 illustrated in FIG. 10 correspond to components indicated by reference numerals 102 to 121 illustrated in FIG. 1, respectively, and thus basically operate in a similar way. The correspondence table illustrated in each of FIGS. 2, 5, and 7, as well as the flowchart illustrated in each of FIGS. 3, 6, and 8 are applicable to the fifth exemplary embodiment.

A part modified from a circuit structure illustrated in FIG. 1 will be described. FIG. 10 illustrates a Pch MOS FET 350 and an Nch MOS FET 355. FIG. 10 further illustrates diodes 352 and 353, resistors 351 and 356, and a capacitor 357.

The gate of the Pch MOS FET 350 is pulled up to a voltage output of a power IC 304 by the resistor 351.

The gates of an Nch MOS FET 320 and the Nch MOS FET 355 are pulled down to a ground, by the resistor 356. The capacitor 357, which is provided to mask a malfunction due to impulse input or noise mixture, connects to the gates of the Nch MOS FET 320 and the Nch MOS FET 355.

A drain output of the Pch MOS FET 350 is applied to the gates of the Nch MOS FET 320 and the Nch MOS FET 355 via the diode 352 and a resistor 322 in a forward direction. In addition, an output of an output port (OUTPUT 1) of a CPU 306 is applied to the gates of the Nch MOS FET 320 and the Nch MOS FET 355 via the diode 353 and the resistor 322 in a forward direction. In other words, a logical OR output of the diodes 352 and 353 drive the gates of the Nch MOS FET 320 and the Nch MOS FET 355. The logical OR output of the diodes 352 and 353 is an output (which corresponds to a hold value 1) of the state holding circuit, and corresponds to the Q output of the D-FF 125.

The capacitor 357 is charged by the logical OR output of the diodes 352 and 353, and the Nch MOS FET 320 and the Nch MOS FET 355 enter an ON (conductive) state. When the Nch MOS FET 355 enters the ON state, the Pch MOS FET 350 also enters the ON state. Afterward, the logical OR output (the hold value 1) of the diodes 352 and 353 become stable regardless of whether the output from the output port (OUTPUT 1) of the CPU 306 is “L” or “H” because the Pch MOS FET 350 is in the ON state.

A state transition operation of the state holding circuit including the Pch MOS FET 350 and the Nch MOS FET 355 will be described.

In a state where a battery 302 is absent, if the battery 302 that outputs a voltage within an operating range of the power IC 304 is connected to the electronic apparatus 301, the power IC 304 outputs a predetermined voltage. The output voltage of the power IC 304 is applied to a source of the Pch MOS FET 350, and to the gate thereof via the resistor 351.

The gate of the Pch MOS FET 350 is pulled up to the output voltage of the power IC 304 by the resistor 351, and therefore, the Pch MOS FET 350 is in an OFF (non-conductive) state. When the Pch MOS FET 350 is in the OFF state and the output of the output port (OUTPUT 1) of the CPU 306 is L, the logical OR output (the hold value 1) of the diodes 352 and 353 are “L”, and therefore, the Nch MOS FET 355 is also in the OFF state. In this way, initially, the Pch MOS FET 350 and the Nch MOS FET 355 are both in the OFF state.

In the fifth exemplary embodiment, a CR time constant circuit includes the resistor 322 and the capacitor 357, to prevent the Pch MOS FET 350 and further the Nch MOS FET 355 from being momentarily turned on due to a variation in gate capacitance of the Pch MOS FET 350. In other words, a CR time constant calculated based on a resistance of the resistor 322 and a capacitance of the capacitor 357 is set to a level that can mask an impulse input to the gate of the Nch MOS FET 355 when the Pch MOS FET 350 changes to OFF state for a moment.

Assume that the CPU 306 changes the output of the output port (OUTPUT 1) to “H”. Subsequently, via the diode 353, the logical OR output (the hold value 1) of the diodes 352 and 353 change to “H”, and the Nch MOS FET 355 changes from the OFF state to the ON state. Then, the Pch MOS FET 350 changes from the OFF state to the ON state. When the Pch MOS FET 350 changes to the ON state, the logical OR output (the hold value 1) of the diodes 352 and 353 change to “H” regardless of the output of the output port (OUTPUT 1) of the CPU 306, and the Nch MOS FET 355 is maintained in the ON state. Accordingly, the Pch MOS FET 350 is also maintained in the ON state. With this loop, the logical OR output (the hold value 1) of the diodes 352 and 353 remains “H”, and this state is maintained as long as the output voltage of the battery 302 connected to the electronic apparatus 301 is within the operating range of the power IC 304.

When the battery 302 is removed, the output voltage of the power IC 304 drops, and therefore, the Nch MOS FET 355 changes to the OFF state, and the Pch MOS FET 350 also changes to the OFF state. When the battery 302 is connected to the electronic apparatus 301 again, the Pch MOS FET 350 and the Nch MOS FET 355 start initial operation from the OFF state. In other words, removing the battery 302 clears (deletes) information which is set in the state holding circuit by the CPU 306 while the battery 302 is connected to the electronic apparatus 301.

A circuit operation of the electronic apparatus 301 is similar to the circuit operation according to the first to fourth exemplary embodiments except for a difference in the circuit structure realizing the state holding circuit.

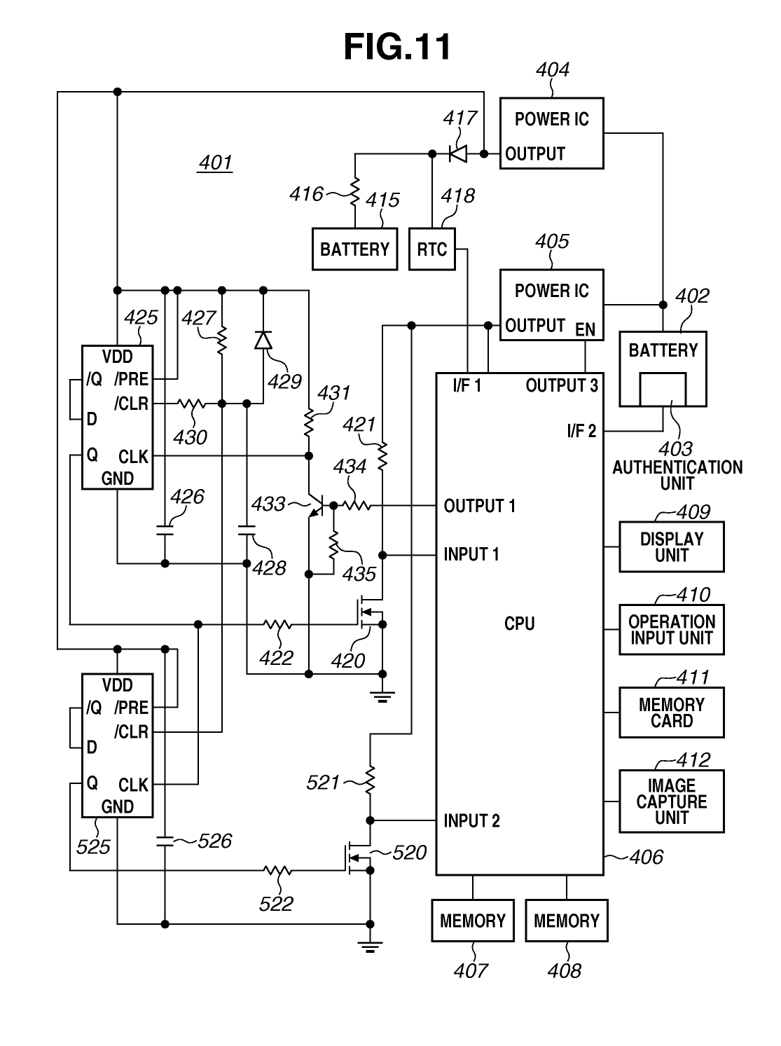

A sixth exemplary embodiment will be described below. FIG. 11 is a diagram illustrating an example of a schematic configuration of an electronic apparatus 401 according to the sixth exemplary embodiment. In the electronic apparatus 401 according to the sixth exemplary embodiment, two D-FFs realize a 2-bit state holding circuit. Components indicated by reference numerals 402 to 431 and 433 to 435 illustrated in FIG. 11 correspond to components indicated by reference numerals 102 to 131 and 133 to 135 illustrated in FIG. 1, respectively, and basically operate in a similar way.

The components added to the configuration illustrated in FIG. 1 and operations thereof will be described. A D-FF 425 is different from the D-FF 125 in following respects. A resistor is not provided that corresponds to the resistor 132 which connects a D terminal and a power terminal VDD. A /Q terminal of the D-FF 425 directly connects to the D terminal.

An output voltage of a power IC 404 is applied to a power terminal VDD and a preset terminal /PRE of a D-FF 525. The power terminal VDD of the D-FF 525 connects to a ground via a capacitance 526. A /Q terminal of the D-FF 525 directly connects to a D terminal. A connection point between resistors 427 and 430 connects to a /CLR terminal of the D-FF 525, and a Q output (which corresponds to a hold value 1) of the D-FF 425 connects to a clock terminal CLK of the D-FF 525. A Q output (which corresponds to a hold value 2) of the D-FF 525 connects to a gate of a MOS FET 520 via a resistor 522. An output port of a power IC 405 connects to the ground via a resistor 421 and a MOS FET 420 in serial connection, and also connects to the ground via a resistor 521 and the MOS FET 520 in serial connection. A connection point between the resistor 521 and the MOS FET 520 connects to an input port (INPUT 2) of a CPU 406.

When a voltage from a power IC 404 is applied to the power terminal VDD of each of the D-FF 425 and the D-FF 525, the Q outputs (the hold values 1 and 2) of the D-FF 425 and the D-FF 525 are cleared (or deleted) by a CR time constant, which is obtained based on a resistance of the resistor 427 and a capacitance of a capacitor 428. As a result, these Q outputs (the hold values 1 and 2) both change to L.

When the output port (OUTPUT 1) of the CPU 406 is L, the Q outputs (the hold values 1 and 2) of the D-FF 425 and the D-FF 525 are in a state 1 (the state 1: the hold value 1=L and the hold value 2=L). The hold value 1 represents the Q output of the D-FF 425, and the hold value 2 represents the Q output of the D-FF 525.

More specifically, when the CPU 406 shifts the output port (OUTPUT 1) from “L” to “H”, the Q output (the hold value 1) of the D-FF 425 changes to “H”, as described above. The Q output (the hold value 1) of the D-FF 425 connects to the clock terminal CLK of the D-FF 525, and therefore, the Q output (the hold value 1) of the D-FF 425 also changes to “H”. In other words, the Q outputs (the hold values 1 and 2) of the D-FF 425 and the D-FF 525 changes into a state 2 (the state 2: the hold value 1=“H” and the hold value 2=“H”).

Further, when the CPU 406 shifts the output port (OUTPUT 1) from “H” to “L”, a state 3 (the state 3: the hold value 1=“L” and the hold value 2=“H”) is realized, and then the CPU 406 shifts the output port (OUTPUT 1) from “L” to “H”, a state 4 (the state 4: the hold value 1=“H” and the hold value 2=“L”) is realized. The state 4 is followed by the state 1. In other words, the shift of the states 1 through 4 is repeated.

When the Q output (the hold value 1) of the D-FF 425 changes to H, the MOS FET 420 enters an ON (conductive) state, and an input port (INPUT 1) of the CPU 406 changes to L. When the Q output (the hold value 2) of the D-FF 525 changes to “H”, the MOS FET 520 enters an ON (conductive) state and the input port (INPUT 2) of the CPU 406 changes to “L”.

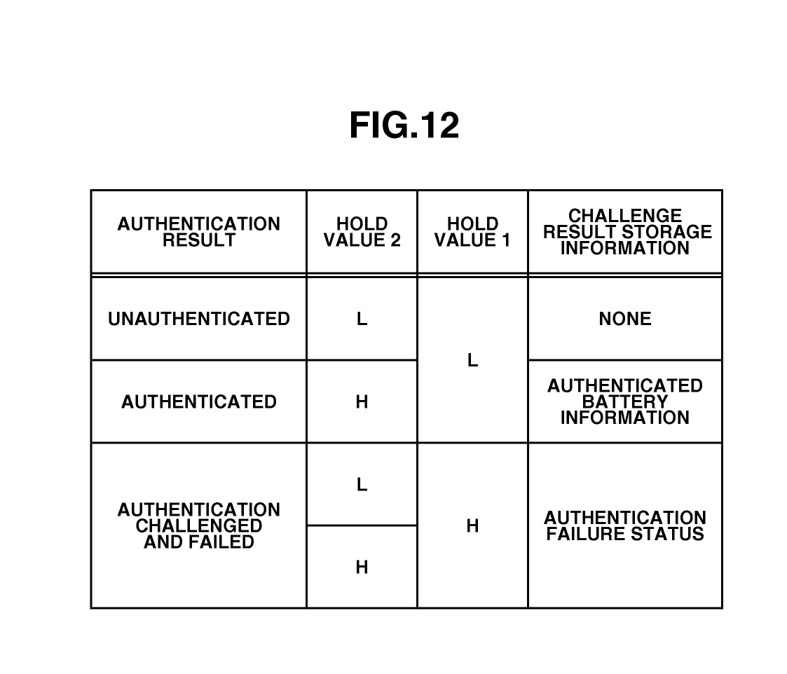

FIG. 12 illustrates a correspondence table illustrating a relationship between an authentication process result of a battery 402 and each of the Q output (the hold value 1) of the D-FF 425 and the Q output (the hold value 2) of the D-FF 525. In the sixth exemplary embodiment, a pair (L:L) of the Q output (the hold value 1) of the D-FF 425 and the Q output of (the hold value 2) of the D-FF 525 is assigned to “unauthenticated”, a pair (L:H) is assigned to “authenticated”, and a pair (H:X) is assigned to “authentication challenged and failed”, where “X” is “L” or “H”.

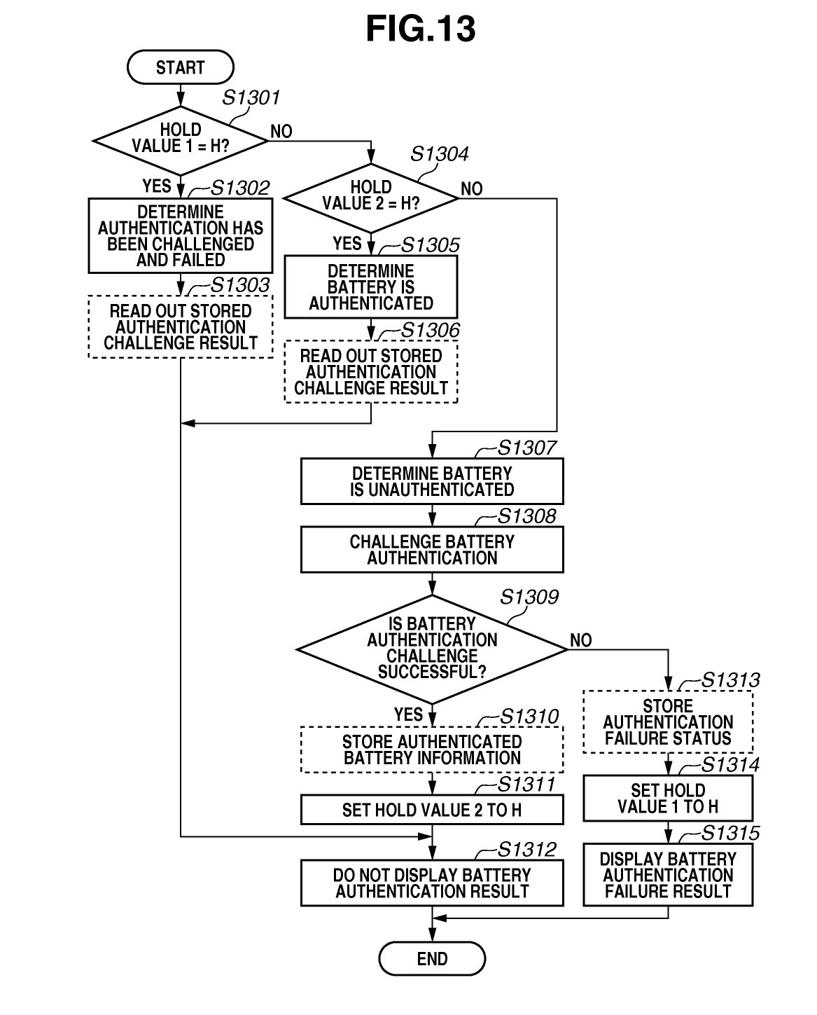

FIG. 13 is a flowchart illustrating an example of a control procedure of a battery authentication process in the sixth exemplary embodiment.

In step S1301, when the electronic apparatus 401 is powered on, the CPU 406 determines whether the Q output (the hold value 1) of the D-FF 425 is “H”. If the Q output (the hold value 1) of the D-FF 425 is “H” (Yes in step S1301), then in step S1302, the CPU 406 determines that the authentication process for the battery 402 currently connected to the electronic apparatus 401 has been already executed and a result thereof is “authentication challenged and failed”. In step S1303, the CPU 406 reads out authentication result detailed information (here “authentication failure status”) from a second memory 408. The CPU 406 may change control of the electronic apparatus 401 based on the authentication result detailed information read out in step S1303. In step S1312, after the authentication result detailed information is read out in step S1303, the CPU 406 does not display the battery authentication result, and terminates the flow illustrated in FIG. 13. Step S1303 may be omitted.

If the Q output (the hold value 1) of the D-FF 425 is “L” (No in step S1301), then in step S1304, the CPU 406 determines whether the Q output (the hold value 2) of the D-FF 525 is “H”. If the Q output (the hold value 2) of the D-FF 525 is “H” (Yes in step S1304), then in step S1305, the CPU 406 determines that an authentication process result for the battery 402 currently connected to the electronic apparatus 401 is “authenticated”. In step S1306, the CPU 406 reads out authentication result detailed information (here “authenticated battery information”) from the second memory 408. The CPU 406 may change control of the electronic apparatus 401 based on the authentication result detailed information read out in step S1306. In step S1312, after the authentication result detailed information is read out in step S1306, the CPU 406 does not display the battery authentication result, and terminates the flow illustrated in FIG. 13. Step S1306 may be omitted.

If the Q output (the hold value 2) of the D-FF 525 is “L” (No in step S1304), then in step S1307, the CPU 406 determines that the authentication process for the battery 402 currently connected to the electronic apparatus 401 has not been executed, i.e., “unauthenticated”. In step S1308, the CPU 406 performs the authentication process with an authentication unit 403 of the battery 402. In step S1309, the CPU 406 determines whether the authentication process for the battery 402 ends successfully. If the result is successful (Yes in step S1309), then in step S1310, the CPU 406 stores the authenticated battery information including the authentication process result in the authentication result memory. In step S1311, the CPU 406 shifts the Q output (the hold value 2) of the D-FF 525 to “H” through the procedure described above. Then in step S1312, the CPU 406 does not display the battery authentication result and terminates the flow illustrated in FIG. 13.

If the authentication process for the battery 402 in step S1308 ends in failure (No in step S1309), then in step S1313, the CPU 406 stores the authentication process result (authentication failure status) in the second memory 408. The authentication failure status includes, for example, information about a date and time when battery authentication process has failed, and a communication log about the failed battery authentication process. In step S1314, the CPU 406 shifts the Q output (the hold value 1) of the D-FF 425 to “H” in the procedure described above. Next, in step S1315, the CPU 406 displays the failure of the battery authentication result on a display unit 409 and terminates the flow illustrated in FIG. 13. Step S1313 may be omitted.

The correspondence table illustrated in FIG. 12 is an example, and a different correspondence may be adopted. In other words, the correspondence between the Q outputs (the hold values 1 and 2) of the D-FFs 425 and 525, and the state may be different from the correspondence in FIG. 12.

In the sixth exemplary embodiment, the authentication result for the battery 402 is stored, so that re-authentication can be omitted unless the battery 402 is removed from the electronic apparatus 401. As a result, a user does not need to wait for the authentication and display of a result thereof.

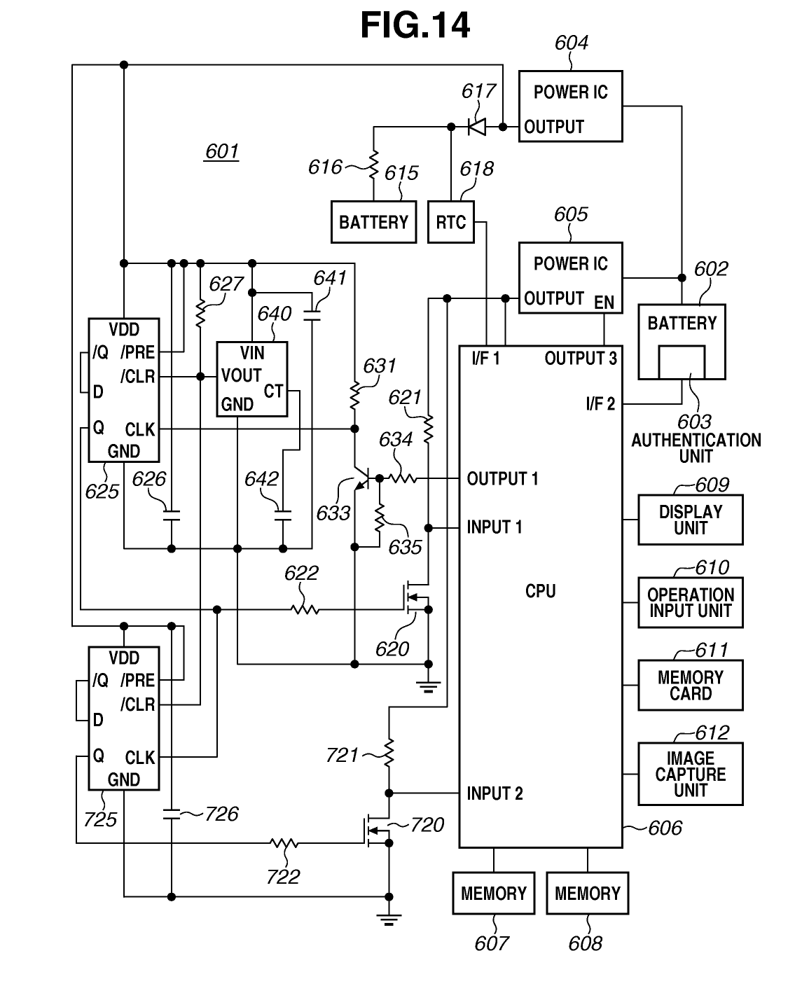

A seventh exemplary embodiment will be described below. FIG. 14 is a diagram illustrating an example of a schematic configuration of an electronic apparatus 601 according to the seventh exemplary embodiment. In the electronic apparatus 601 according to the seventh exemplary embodiment, two D-FFs 625 and 725 realize a 2-bit state holding circuit, and further, a voltage detection circuit 640 is added to stabilize an initial operation. Components indicated by reference numerals 602 to 627, 633 to 635, and 720 to 726 illustrated in FIG. 14 correspond to components indicated by reference numerals 402 to 427, 433 to 435, and 520 to 526 illustrated in FIG. 11, respectively, and basically operate in a similar way. Components indicated by reference numerals 640 to 642 illustrated in FIG. 14 correspond to components indicated by reference numerals 240 to 242 illustrated in FIG. 9, respectively, and basically operate in a similar way. The correspondence table illustrated FIG. 12 and the flowchart illustrated in FIG. 13 are applicable to the seventh exemplary embodiment.

The voltage detection circuit 640 detects an output voltage of a power IC 604. The voltage detection circuit 640 sets an output VOUT to “L” if the detected voltage is less than a threshold voltage, and sets the output VOUT to H if the detected voltage is equal to or greater than the threshold voltage. The voltage detection circuit 640 uses the output voltage of the power IC 604 as a power supply, and therefore constantly operates regardless of whether the electronic apparatus 601 is powered on or off. The output VOUT of the voltage detection circuit 640 connects to a /CLR terminal of each of the D-FFs 625 and 725.

A capacitor 642 is provided to set a delay time which corresponds to the time period from when the voltage equal to or greater than the threshold voltage is detected by the voltage detection circuit 640 until when the output VOUT transitions from L to H. The capacitor 642 is set to have a capacitance that can realize the delay time that is sufficient or more than sufficient to stabilize the voltage of the power IC from when the power IC 604 begins to output an appropriate voltage after a battery 602 is connected to the electronic apparatus 601.

By providing the voltage detection circuit 640, an initial logical value of the /CLR terminal of each of the D-FFs 625 and 725 can be obtained more stably than in the configuration illustrated in FIG. 1.

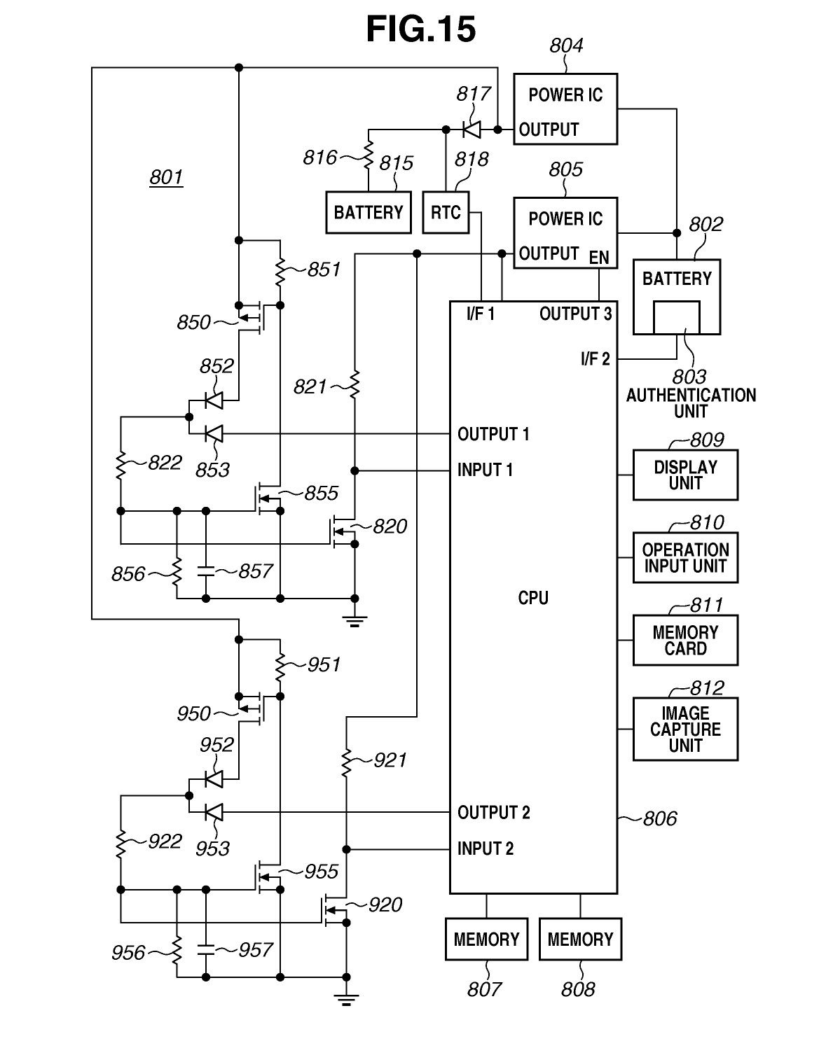

An eighth exemplary embodiment will be described below. FIG. 15 is a diagram illustrating an example of a schematic configuration of an electronic apparatus 801 according to the eighth exemplary embodiment. In the electronic apparatus 801 according to the eighth exemplary embodiment, a state holding circuit having a similar configuration is added in parallel to the state holding circuit including the components 322 and 350 to 357 in the electronic apparatus 301 illustrated in FIG. 10. This allows the electronic apparatus 801 to store three authentication process states or authentication results. Components indicated by reference numerals 802 to 857 illustrated in FIG. 15 correspond to components indicated by reference numerals 302 to 357 illustrated in FIG. 10, respectively, and basically operate in a similar way. The correspondence table illustrated FIG. 12 and the flowchart illustrated in FIG. 13 are applicable to the eighth exemplary embodiment.

When it is desired to change a logical OR output (which corresponds to a hold value 1) of diodes 852 and 853 to “H”, a CPU 806 temporarily changes an output of an output port (OUTPUT 1) to “H”. Similarly, when it is desired to change a logical OR output (which corresponds to a hold value 2) of diodes 952 and 953 to “H”, the CPU 806 temporarily changes an output of an output port (OUTPUT 2) to “H”. As long as a battery 802 remains connected to the electronic apparatus 801 and an output of the battery 802 is within an operating range of a power IC 804, an output voltage of the power IC 804 maintains the hold values 1 and 2 set by the CPU 806 in the above-described manner.

A ninth exemplary embodiment will be described below. In each of the first, fourth, sixth, and seventh exemplary embodiments, the state holding circuit is realized by the D-FF. However, the state holding circuit may be realized by a circuit element other than the D-FF. For example, the state holding circuit may include a circuit element, such as a JK-FF, a SR-FF, and a T-FF. The state holding circuit may be configured with any circuit element that can set an output initial value, shift an output state by external control, and restore the state to the initial value when power supply stops.

In each of the fifth and eighth exemplary embodiments, the state holding circuit is realized by using the Pch MOS FET and the Nch MOS FET. However, the state holding circuit may be realized by using other type of circuit element. For example, the state holding circuit may be configured with other types of transistor such as a PNP transistor, an NPN transistor, and an FET. The state holding circuit may be configured with any circuit element that can set an output initial value, shift an output state by external control, and restore the state to the initial value when power supply stops.

It is desirable that the state holding circuit consumes low power in the first to eighth exemplary embodiments. It is desirable that the state holding circuit including a peripheral circuit consumes, for example, 500 μA or less current.

According to the first to eighth exemplary embodiments, electric power for operating the state holding circuit may be supplied from a power IC that operates with electric power from a removable battery, but may be directly supplied from the removable battery.

In the case described in the first to eighth exemplary embodiments, the CPU of the electronic apparatus and the authentication unit of the battery are connected via a wired communication interface unit. Alternatively, this connection may be realized via a communication interface unit other than the wired communication interface unit. For example, a wireless communication interface unit may be used in place of the wired communication interface unit.

A tenth exemplary embodiment will be described below. Various functions, processes, and methods described in the first to ninth exemplary embodiments can also be realized by a personal computer, a microcomputer, a CPU, or the like, using a program. In the tenth exemplary embodiment, the personal computer, the microcomputer, the CPU, or the like will be hereinafter referred to as a “computer X”. In addition, in the tenth exemplary embodiment, a “program Y” refers to a program which is provided to control the computer X and to implement the various functions, processes, and methods described in the first to ninth exemplary embodiments.

The various functions, processes, and methods described in the first to ninth exemplary embodiments are realized by the computer X executing the program Y. In this case, the program Y is supplied to the computer X via a computer readable storage medium. The computer readable storage medium according to the tenth exemplary embodiment includes at least one of a hard disk device, an optical disc, a CD-ROM (compact disc read only memory), a CD-R (compact disc recordable), a memory card, and a ROM (read only memory), a RAM (random access memory). The computer readable storage medium according to the tenth exemplary embodiment is a non-transitory storage medium.

For example, the computer readable storage medium according to the tenth exemplary embodiment stores a program for controlling the processes described with reference to at least one of FIGS. 3, 6, 8, and 13.

While the present invention is described with reference to exemplary embodiments, it is to be understood that the present invention is not limited to the exemplary embodiments. The scope of the following claims is to be accorded the broadest interpretation so as to encompass all such modifications and equivalent structures.

This application claims priority from Japanese Patent Application No. 2014-184588, filed Sep. 10, 2014, which is hereby incorporated by reference herein in its entirety.

What is claimed is:

1. An electronic apparatus comprising:
an authentication unit that executes an authentication process for authenticating a battery connected to the electronic apparatus;
a holding unit that holds a value representing a result of the authentication process, wherein the value held by the holding unit is deleted in a case where the battery is removed from the electronic apparatus, or in a case where a voltage of the battery is equal to or less than a predetermined value; and
a control unit that performs control to determine whether to cause the authentication unit to execute the authentication process according to the value held by the holding unit.

2. The electronic apparatus according to claim 1, wherein, in a case where the authentication process results in failure, the holding unit holds a value different from an initial value.

3. The electronic apparatus according to claim 1, wherein, in a case where the value held by the holding unit is a value different from an initial value, the control unit determines that the authentication process results in failure.

4. The electronic apparatus according to claim 3, further comprising a display unit,
wherein, in a case where it is determined that the authentication process results in failure, the control unit prevents information about authentication of the battery from being displayed on the display unit.

5. The electronic apparatus according to claim 1, wherein, in a case where the authentication process results in success, the holding unit holds a value different from an initial value.

6. The electronic apparatus according to claim 1, wherein, in a case where the value held by the holding unit is a value different from an initial value, the control unit causes the authentication unit not to execute the authentication process.

7. The electronic apparatus according to claim 6, further comprising a display unit,
wherein, in a case where it is determined that the authentication process results in success, the control unit prevents information about authentication of the battery from being displayed on the display unit.

8. The electronic apparatus according to claim 1, wherein, in a case where the authentication process is executed by the authentication unit, the holding unit holds a value different from an initial value.

9. The electronic apparatus according to claim 1, wherein, in a case where the value held by the holding unit is a value different from an initial value, the control unit causes the authentication unit not to execute the authentication process.

10. The electronic apparatus according to claim 9, further comprising a display unit,

11. A method comprising:
causing an authentication unit to execute an authentication process for authenticating a battery connected to the electronic apparatus;
causing a holding unit to hold a value representing a result of the authentication process, wherein the value held by the holding unit is deleted in a case where the battery is removed from the electronic apparatus, or in a case where a voltage of the battery is equal to or less than a predetermined value; and
performing control to determine whether to cause the authentication unit to execute the authentication process according to the value held by the holding unit.

12. A non-transitory storage medium that stores a program for causing a computer to execute a method, the method comprising:
causing an authentication unit to execute an authentication process for authenticating a battery connected to the electronic apparatus;
causing a holding unit to hold a value representing a result of the authentication process, wherein the value held by the holding unit is deleted in a case where the battery is removed from the electronic apparatus, or in a case where a voltage of the battery is equal to or less than a predetermined value; and
performing control to determine whether to cause the authentication unit to execute the authentication process according to the value held by the holding unit.
